(19) United States
(12) Patent Application Publication
(10) Pub. No.: US 2024/0046400 A1
(43) Pub. Date: Feb. 8, 2024

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yoshikazu JIKUHARA, Miyoshi-shi (JP); Yoshinori KANEMITSU, Tachikawa-shi (JP); Yurika TANAKA, Yokosuka-shi (JP); Keiichi UNO, Chita-gun (JP)

(73) Assignee: TOYOTA JIDOSHA KABUSHIKI KAISHA, Toyota-shi (JP)

(21) Appl. No.: 18/331,983

(22) Filed: Jun. 9, 2023

(30) Foreign Application Priority Data
Aug. 2, 2022 (JP) 2022-123569

(51) Int. Cl. G06Q 50/30; G07B 15/02; G06Q 30/0283; G06Q 30/0207

(52) U.S. Cl. CPC G06Q 50/30; G07B 15/02; G06Q 30/0284; G06Q 30/0239; G06Q 2240/00

(57) ABSTRACT

A controller is provided which is configured to dispatch a bus to a predetermined facility in response to receiving information about payment from a terminal that is arranged in the predetermined facility to make a payment of a usage fee for the bus.

### CROSS REFERENCE TO THE RELATED APPLICATION

This application claims the benefit of Japanese Patent Application No. 2022-123569, filed on Aug. 2, 2022, which is hereby incorporated by reference herein in its entirety.

### BACKGROUND

### Technical Field

The present disclosure relates to an information processing apparatus, an information processing method, and a non-transitory storage medium storing a program.

### Description of the Related Art

It is known to display bus stops for demand-type buses on terminals of users (see, for example, Patent Literature 1).

### CITATION LIST

### Patent Literature

Patent Literature 1: International Publication No. WO 2018/225320

### SUMMARY

The object of the present disclosure is to make it easier to use demand-type buses.

One aspect of the present disclosure is directed to an information processing apparatus including a controller configured to dispatch a bus to a predetermined facility in response to receiving information about payment from a terminal that is arranged in the predetermined facility to make a payment of a usage fee for the bus.

Another aspect of the present disclosure is directed to an information processing method comprising dispatching, by a computer, a bus to a predetermined facility in response to receiving information about payment from a terminal that is arranged in the predetermined facility to make a payment of a usage fee for the bus.

A further aspect of the present disclosure is directed to a non-transitory storage medium storing a program for causing a computer to dispatch a bus to a predetermined facility in response to receiving information about payment from a terminal that is arranged in the predetermined facility to make a payment of a usage fee for the bus.

In addition, a still further aspect of the present disclosure is directed to the program described above.

According to the present disclosure, it becomes possible to make it easier to use demand type buses.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of a payment terminal, a user terminal, a server, and an in-vehicle device in a bus, and a store terminal, which together constitute the system according to the embodiment;

FIG. 3 is a diagram illustrating an example of a functional configuration of the server;

FIG. 4 is a view illustrating an example of a table structure of a user information DB;

FIG. 5 is a view illustrating an example of a table structure of a payment terminal information DB;

FIG. 6 is a view illustrating an example of a table structure of a bus information DB;

FIG. 7 is a diagram illustrating a functional configuration of the payment terminal;

FIG. 8 is a flowchart of processing of generating an operation command for a bus in a server according to a first embodiment;

FIG. 9 is a flowchart of processing of providing an incentive to a store and providing a coupon to a user in a server according to a second embodiment; and

FIG. 10 is a view illustrating an example of a table structure of a payment terminal information DB according to the second embodiment.

### DESCRIPTION OF THE EMBODIMENTS

An information processing apparatus, which is one aspect of the present disclosure, includes a controller. The controller is configured to dispatch a bus to a predetermined facility in response to receiving information about payment from a terminal that is arranged in the predetermined facility to make a payment of a usage fee for the bus. The bus is, for example, a demand type bus (on-demand bus). In an on-demand bus, there may be no permanent sign at a bus stop of the bus (hereinafter, also simply referred to as a bus stop), and a predetermined facility such as, for example, a store or the like can be set as a bus stop. In this case, a road around the predetermined facility or a parking lot of the predetermined facility may be used as a bus stop.

Here, on-demand buses may use a relatively small bus. In such a bus, if a device for paying bus fares is installed inside the bus, there is a concern that the space available for users to ride may become narrow. On the other hand, if users have paid their fares before boarding the bus, there is no need to install a device for paying the fares inside the bus. However, for example, in order for users to pay fares by using credit cards, prepaid cards or the like, a terminal for making payments is required. Even if this terminal is placed at a bus stop, it is costly because of the need to secure power supply and communication lines. In addition, a place where the terminal is installed is also required.

On the other hand, by arranging the terminal in the predetermined facility, it is possible to secure a place where the terminal is to be installed, and to receive the provision of electric power and communication lines from the predetermined facility. Then, the controller dispatches a bus to the predetermined facility by using, as a trigger, the fact that the payment has been made in the predetermined facility. For example, if the place or location of the predetermined facility has been registered in advance, it is possible to identify the location where the payment was made, and thus to dispatch a bus to that location. In addition, since a user can call a bus by making a payment, the user does not need to make a separate reservation for the bus, and can call the bus immediately. Here, note that, as an alternative, a user may reserve a bus, so that the bus can be dispatched by using a payment as a trigger.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

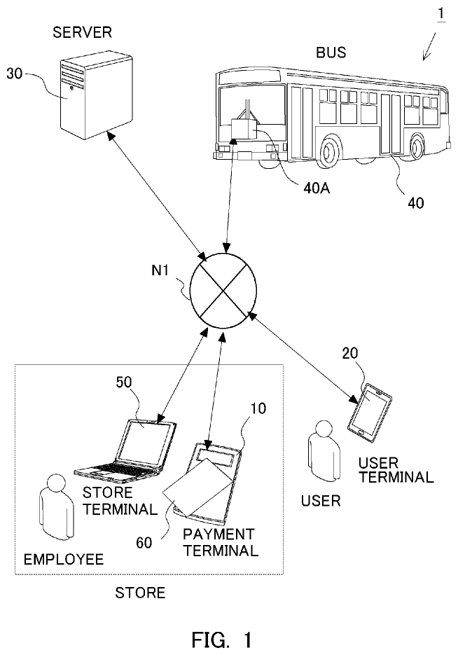

FIG. 1 is a view illustrating a schematic configuration of a system 1 according to an embodiment. The system 1 is configured to dispatch a bus 40 to a store in which a payment terminal 10 is arranged, when a server 30 receives information about payment of a usage fee for the bus from the payment terminal 10 arranged in the store. The store is an example of a predetermined facility. The server 30 generates a route for the bus 40 based on the position or location of the store where the payment terminal 10, in which the payment has been made, is located, and transmits the route to the bus 40. Here, note that in the following, a stop point or location of the bus 40 indicates a boarding point where a user is to get on the bus 40 or an alighting point where the user is to get off the bus 40.

When a user pays the usage fee for the bus 40 by using the payment terminal 10, a usage request is transmitted from the payment terminal 10 to the server 30. Upon receiving this usage request, the server 30 dispatches the bus 40 to the point or location where the payment terminal 10 is located. The usage request is information for the user to use the bus 40. The usage request includes information about a boarding point where the user gets on the bus 40, a boarding date and time when the user gets on the bus 40, and an alighting point where the user gets off the bus 40. The boarding point is a point where the payment terminal 10 is located, and the boarding date and time is a date and time when the payment was made.

Here, note that the user can also reserve the bus by using a user terminal 20. However, even if the user reserves the bus 40, the bus 40 will not be dispatched until the payment is made at the payment terminal That is, in the present embodiment, the payment at the payment terminal 10 serves as a trigger for dispatching the bus 40. Here, note that in the present embodiment, even if the user does not reserve the bus 40, the bus is dispatched to the point where the payment terminal 10 is located, by the user making the payment at the payment terminal 10.

The bus 40 is a vehicle in demand-type transportation that is operated in response to the payment made by users. The bus 40 is, for example, a vehicle that is driven by a driver, but as an alternative, the bus may be a vehicle that is capable of autonomous driving. For autonomous driving of the bus 40, known technologies can be used. The bus 40 travels in a route including the boarding point and the alighting point of each user. Note that a road or street around the store in which payment has been made or a parking lot of the store may be used as a bus stop. The route of the bus 40 may be determined by, for example, the server 30. Also, note that the bus 40 is not limited to a large vehicle, but may be a small passenger vehicle or the like. Here, note that in the present embodiment, the boarding points are limited to the points where the payment terminals 10 are arranged, but as an alternative, the boarding points may include points where the payment terminals 10 are not arranged. In this case, for example, a user may make a payment in advance by using the user terminal 20, or a terminal for payment may be arranged in the bus 40.

The server 30 is a device that manages the operation of buses 40. In cases where the payment of a usage fee has been made, the server 30 determines a bus 40 to be dispatched to the location of the store where the payment has been made, generates an operation command for the bus and transmits the operation command to the bus 40.

The payment terminal 10 is, for example, a terminal that makes a payment by means of a credit card 60. The payment terminal 10 may also be used as a terminal that makes a payment when an item is purchased in the store. The store terminal 50 is a terminal used by employees of the store in which the payment terminal 10 is located. Here, note that the payment terminal 10 and the store terminal 50 may be a single terminal.

The payment terminal 10, the user terminal 20, the server 30, the bus 40, and the store terminal 50 are connected to one another by means of a network N1. The network N1 is, for example, a worldwide public communication network such as the Internet or the like, and a WAN (Wide Area Network) or other communication networks may be adopted. Also, the network N1 may include a telephone communication network such as a mobile phone network or the like, or a wireless communication network such as Wi-Fi (registered trademark) or the like.

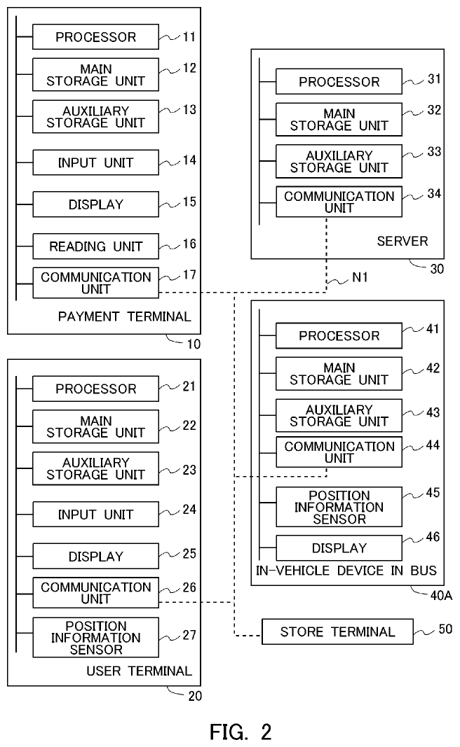

The hardware configuration of the payment terminal 10, the user terminal 20, the server 30, the in-vehicle device 40A of the bus 40, and the store terminal 50 will be described based on FIG. 2. FIG. 2 is a block diagram schematically illustrating an example of a configuration of each of the payment terminal 10, the user terminal 20, the server 30, and the in-vehicle device 40A in the bus 40, and the store terminal 50, which together constitute the system 1 according to the embodiment;

The server 30 has a configuration of a computer. The server 30 includes a processor 31, a main storage unit 32, an auxiliary storage unit 33, and a communication unit 34. These components are mutually connected to one another by means of a bus. The processor 31 is an example of a controller. Also, the main storage unit 32 and the auxiliary storage unit 33 are examples of a memory.

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. As a result, the server 30 realizes functions that match predetermined purposes. The main storage unit 32 and the auxiliary storage unit 33 are computer readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the payment terminal 10, the user terminal 20, the in-vehicle device 40A of the bus 40, and the store terminal 50 via the network N1. The communication unit 34 is, for example, a LAN (Local Area Network) interface board, a wireless communication circuit for wireless communication, or the like. The LAN interface board or the wireless communication circuit is connected to the network N1.

The payment terminal 10 is typically a card reader. The payment terminal 10 has a configuration of a computer. The payment terminal 10 includes a processor 11, a main storage unit 12, an auxiliary storage unit 13, an input unit 14, a display 15, a reading unit 16, and a communication unit 17. These components are mutually connected to one another by means of a bus. The processor 11, the main storage unit 12, the auxiliary storage unit 13, and the communication unit 17 are the same as the processor 31, the main storage unit 32, the auxiliary storage unit 33, and the communication unit 34 of the server 30, respectively, and hence, the description thereof will be omitted.

The input unit 14 is a means or unit that receives an input operation performed by a user, and is, for example, a touch panel, a mouse, a numeric keypad, a keyboard, a push button, or the like. The display 15 is a means or unit that presents information to the user, and is, for example, an LCD (Liquid Crystal Display), an EL (Electroluminescence) panel, or the like. The input unit 14 and the display 15 may be configured as a single touch panel display.

The reading unit 16 is a means or unit for reading information about payment from a contact type IC card, a non-contact type IC card, a magnetic stripe card, a barcode, a two-dimensional code, a user terminal 20, or the like. The reading unit 16 may be, for example, a circuit that performs a short-range wireless communication with a non-contact type IC card or the user terminal 20, or may be a CCD (Charge Coupled Device) image sensor or a CMOS (Complementary Metal Oxide Semiconductor) image sensor that captures a two-dimensional code displayed on the user terminal 20.

The communication unit 17 is a communication means or unit that connects the payment terminal 10 to the network N1. The communication unit 17 is, for example, a circuit that communicates with other devices (e.g., the server 30 and the like) via the network N1 by making use of a LAN (Local Area Network) interface board, a mobile communication service (e.g., a telephone communication network such as 6G (6th Generation), 5G (5th Generation), 4G (4th Generation), 3G (3rd Generation), or LTE (Long Term Evolution)), or a wireless communication network such as Wi-Fi (registered trademark) or the like. Here, note that in the present embodiment, the server 30 makes the payment, but instead of this, another server (payment server) may make the payment, and the payment server may notify the server 30 that the payment has been made. In this case, the communication unit 17 of the payment terminal 10 communicates with the payment server. In addition, in the present embodiment, the user makes the payment by using the credit card 60, but as an alternative, the user terminal 20 can be used to make the payment. For payment methods, there can be used known techniques.

Now, the user terminal 20 will be described. The user terminal 20 is, for example, a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, a communication unit 26, and a position information sensor 27. These components are mutually connected to one another by means of a bus. The processor 21, the main storage unit 22 and the auxiliary storage unit 23 are the same as the processor 31, the main storage unit 32 and the auxiliary storage unit 33 of the server 30, respectively, and hence, the description thereof will be omitted. Also, the input unit 24 and the display 25 are the same as the input unit 14 and the display 15 of the payment terminal 10, respectively, and hence, the description thereof will be omitted.

In addition, the communication unit 26 is a communication means or unit for connecting to the network N1, and is also a circuit for communicating with another device (e.g., the payment terminal 10, the server 30, or the like) via the network N1 by making use of a mobile communication service (e.g., a telephone communication network such as 6G (6th Generation), 5G (5th Generation), 4G (4th Generation), 3G (3rd Generation), LTE (Long Term Evolution) or the like), and/or a wireless communication network such as Wi-Fi (registered trademark), Bluetooth (registered trademark) Low Energy, NFC (Near Field Communication), UWB (Ultra Wideband) or the like.

The position information sensor 27 obtains position information (e.g., latitude and longitude) of the user terminal 20 at predetermined intervals. The position information sensor 27 is, for example, a GPS (Global Positioning System) receiver unit, a wireless communication unit or the like. The information obtained by the position information sensor 27 is recorded, for example, in the auxiliary storage unit 23 or the like and transmitted to the server 30.

Here, note that the configuration of the store terminal 50 is the same as that of the user terminal 20, and hence, the description thereof will be omitted.

Next, the bus 40 is provided with the in-vehicle device 40A. The in-vehicle device 40A has a configuration of a computer. The in-vehicle device 40A of the bus 40 includes a processor 41, a main storage unit 42, an auxiliary storage unit 43, a communication unit 44, a position information sensor 45, and a display 46. These components are mutually connected to one another by means of a bus. The processor 41, the main storage unit 42, and the auxiliary storage unit 43 are the same as the processor 31, the main storage unit 32, and the auxiliary storage unit 33 of the server 30, respectively, and hence, the description thereof will be omitted. In addition, the communication unit 44, the position information sensor 45, and the display 46 are the same as the communication unit 26, the position information sensor 27, and the display 25 of the user terminal respectively, and hence, the description thereof will be omitted. Note that the bus 40 may be, for example, a moving body or vehicle that can autonomously travel. In this case, the processor 41 controls the bus 40 based on commands or instructions from the server 30. Also, in cases where the bus 40 is a manual vehicle operated by a driver, the in-vehicle device 40A may be a navigation device. In this case, the processor 41 may display the route of the bus 40 on the display 46 together with a map.

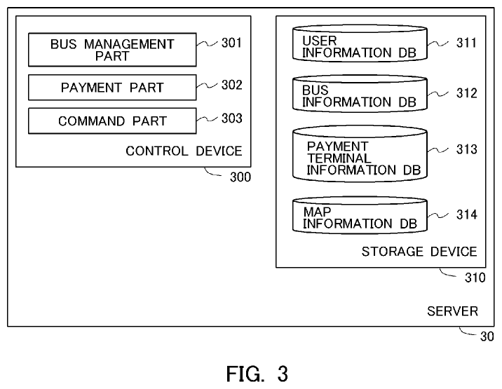

Then, the functions of the server 30 will be described. FIG. 3 is a diagram illustrating an example of a functional configuration of the server 30. The server 30 includes, as its functional components, a control device 300 and a storage device 310. The processor 31 of the server 30 executes the processing of the control device 300 by means of a computer program on the main storage unit 32. However, any of the individual functional components or a part of the processing thereof may be implemented by a hardware circuit. The control device 300 includes a bus management part 301, a payment part 302 and a command part 303.

In addition, the storage device 310 is configured to include the main storage unit 32 and the auxiliary storage unit 33. The storage device 310 stores a user information DB 311, a bus information DB 312, a payment terminal information DB 313, and a map information DB 314. The user information DB 311, the bus information DB 312, the payment terminal information DB 313, and the map information DB 314 are, for example, relational databases.

Here, note that any of the individual functional components of the server 30 or a part of the processing thereof may be executed by another computer connected to the network N1.

The bus management part 301 collects information about buses 40 and updates the bus information DB 312, which will be described later. Specifically, the bus management part 301 periodically communicates with a plurality of buses 40 and collects information about the current positions or locations of the buses 40. The information thus collected is reflected in the bus information DB 312 to be described later.

Moreover, the bus management unit 301 obtains a usage request from each user who wants to use a bus. The usage request is information transmitted from each payment terminal 10 to the server 30 when each user makes a payment at the payment terminal 10 using a credit card 60. The usage request includes information about the user ID, the point or location where the user made the payment (hereinafter, also referred to as a payment point), the date and time when the user made the payment (hereinafter, also referred to as a payment date and time), the alighting point desired by the user, the number of persons who use the bus 40, and the like. These pieces of information include information associated with the credit card 60 and information entered by the user via the input unit 14. Note that, as an alternative, the usage request may include the information obtained by the payment terminal 10 from the user terminal 20 through short-range wireless communication between the user terminal 20 and the payment terminal 10. In this case, the payment may be made based on the information transmitted from the user terminal 20.

The user ID is an identifier unique to the user. The user ID is assigned, for example, by the server 30 or the payment terminal 10 at the time of payment. Here, note that, as an alternative, the user may have made in advance a user registration for the use of the bus in the server 30 by using the user terminal 20. At this time, user information including the user's name and the like is stored in the auxiliary storage unit 33 in association with the user ID. Also, the relationship between the user ID and the user terminal 20 used by the user may have been stored in the auxiliary storage unit 33.

The information about the point at which the user has made the payment is information that can identify the location of the store where the payment terminal 10, in which the user has made the payment, is located. For example, in cases where the location of the store where the payment terminal 10 is located has been stored in the auxiliary storage unit 33 of the server 30, information for identifying the payment terminal 10 (e.g., the payment terminal ID to be described below) may be obtained as information about the point where the user made the payment. In addition, the date and time when the user made the payment may be a date and time at the point of time when the user made the payment. Here, note that, as an alternative, it may be a date and time when the user made a predetermined input via the input unit 14 of the payment terminal 10. Also, the information about the alighting point desired by the user and the number of persons using the alighting point may be information entered by the user via the input unit 14. Information about the payment point (which may be the boarding point), the payment date and time (which may be the boarding date and time), the alighting point, the number of persons, and the like included in the usage request is stored in the user information DB 311.

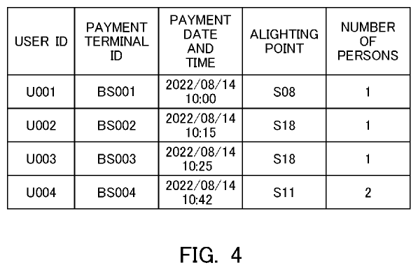

Here, FIG. 4 illustrates an example of a table structure of the user information DB 311. The user information DB 311 has fields for user ID, payment terminal ID, payment date and time, alighting point, and number of persons. In the user ID field, information that can identify each user (user ID) is entered. The payment terminal ID field stores information (payment terminal ID) that can identify each payment terminal 10 included in each usage request. Since each payment terminal ID is associated with the position or location where each payment terminal 10 is located, the payment terminal ID is also used as information indicating a point or location to which a bus is dispatched. Since the payment terminal ID field is used as information for identifying each boarding point for each bus 40, other information may be stored there in place of the payment terminal ID. For example, instead of the payment terminal ID, information (store ID) that can identify a store where a payment was made may be stored. In addition, instead of the payment terminal ID, information about the coordinates (latitude and longitude), the address, the name of a building, or the like of the place where the payment was made may be stored. As a further alternative, for example, the position information of the user terminal 20 that made the payment at the time of payment may be stored. Note that the stores where the payment terminals 10 are located have been registered in advance, and the relationship between the payment terminal IDs and the locations of the stores has been stored in the payment terminal information DB 313, which will be described later.

The payment date and time field stores information about the payment date and time included in each usage request. The payment date and time is a date and time at which each user made a payment in each payment terminal 10, and is a date and time at which each user wants to board a bus 40.

The alighting point field stores information about an alighting point included in each usage request. The alighting point is a point or location at which a user wants to get off the bus 40, and is indicated, for example, by the coordinates (latitude and longitude) or the address thereof, the name of a building, the name or number of a bus stop, or the like. Here, note that alighting points may be points or locations that have been registered in advance in the auxiliary storage unit 33 of the server 30 as points or locations where the bus 40 can stop. Then, the information about the alighting points may be transmitted to the payment terminal 10, and may be displayed on the display 15 of the payment terminal 10. In this case, a user selects a desired alighting point from among the alighting points displayed on the display 15. The number of persons field stores information about the number of persons included in each usage request. This number of persons is the number of persons who want to board the bus 40.

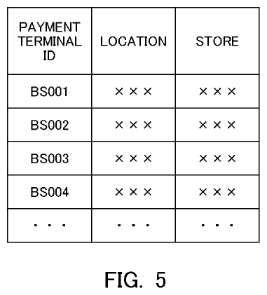

Here, FIG. 5 is a view illustrating an example of a table structure of a payment terminal information DB 313. The payment terminal information DB 313 has fields for payment terminal ID, location, and store. In the payment terminal ID field, information (payment terminal ID) that can identify each payment terminal 10 is entered. In the location field, information about the location of each store where a payment terminal 10 is located is entered. This location is represented, for example, by coordinates, an address, or a name of a building. In the store field, information about the name of each store is entered. These pieces of information have been registered in advance by the store terminal 50.

Upon receiving a usage request from a payment terminal 10, the command part 303 selects a bus 40 that can be dispatched (hereinafter, also referred to as a dispatchable bus), based on information such as a payment point, a payment date and time, an alighting point, the number of persons, etc., included in the usage request. The dispatchable bus 40 is a bus 40 that has vacant seats for the number of persons, and that can be moved to the payment point and then to the alighting point. For example, a bus 40 that has a reservation to board or alight at another point on the same date and time does not qualify as a bus 40 that can move to the payment point on the payment date and time. Therefore, the dispatchable bus 40 may be selected according to the route of the bus 40 at the present time

Further, upon selecting the dispatchable bus 40, the command part 303 generates an operation command, which is a command for operating the bus 40. The operation command includes, for example, a route of the bus 40. The command part 303 generates the route based on the map information stored in the map information DB 314. The command part 303 generates, for example, the operation command so that the bus 40 departs from its current location and travels via the payment point and the alighting point of each user.

Here, note that the map information DB 314 stores, as map information, for example, link data about roads (links), node data about node points, intersection data about each intersection, search data to search routes, store data about stores, search data to search points, etc.

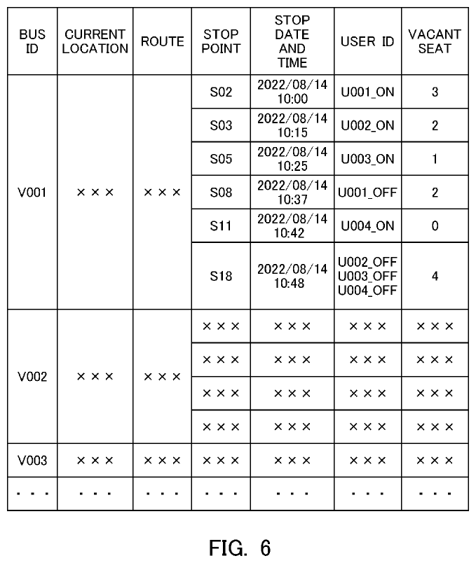

The command part 303 updates the bus information DB 312 upon generating the operation command for the bus 40. Here, the structure or configuration of the bus information stored in the bus information DB 312 will be described based on FIG. 6. FIG. 6 is a view illustrating an example of a table structure of the bus information DB 312. A bus information table has fields for bus ID, current location, route, stop point, stop date and time, user ID, and vacant seat, respectively. In the bus ID field, information that can identify each bus 40 (bus ID) is entered. A bus ID is assigned to each bus 40, for example, by the bus management part 301. In the current location field, information about the current position or location of each bus 40 (position information) is entered. The current location of each bus 40 is detected by the position information sensor 45 of the bus 40, and transmitted to the server 30. The current location field is updated each time position information is received from each bus 40.

In the route field, information about the route of each bus 40 is entered. In the stop point field, information about a point where each bus 40 stops is entered. In the stop point field, information about a point that can be the destination of each bus 40, such as coordinates, an address, or a name of a building, is entered. A point at which a bus 40 stops is a point at which a user gets on or off, and is entered based on the information about the payment point or alighting point of any user stored in the user information DB 311. Here, note that a stop point column is arranged in the order in which each bus 40 stops. In the stop date and time field, information about a stop date and time of each bus 40 corresponding to each stop point thereof is entered. Here, note that a date and time when a user gets off a bus 40 at an alighting point may be calculated based on a boarding time of the user and a time required for the bus 40 to move from a boarding point of the user to the alighting point. The time required for the movement of the bus 40 can be calculated from the past data, the distance of the movement or the like, so that a date and time of arrival at the alighting point may be calculated based on this time.

In the user ID field, an identification symbol (user ID) unique to each user is entered. In addition, a string corresponding to boarding or alighting is added after each user ID. When a user gets on at the corresponding stop, a string “ON” is added after the user ID of the user, and when getting off at the corresponding stop, a string OFF is added after the user ID. In the vacant seat field, the number of vacant seats on each bus 40 at the time of departing from the corresponding stop point is stored.

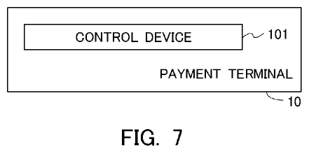

Now, the functions of the payment terminal 10 will be described. FIG. 7 is a diagram illustrating a functional configuration of the payment terminal 10. The payment terminal 10 includes a control device 101 as its functional component. The processor 11 of the payment terminal 10 executes the processing of the control device 101 by a computer program on the main storage unit 12. However, any of the individual functional components or a part of the processing thereof may be implemented by a hardware circuit.

The control device 101 generates a usage request based on an input to the input unit 14, information obtained from the credit card 60, or information obtained from the user terminal 20, and transmits the usage request to the server 30. The usage request includes information about a user ID, a payment terminal ID or a payment point, a payment date and time, an alighting point, the number of persons, and a payment. The information about the payment is, for example, a credit card number.

The control device 101 prompts a user to input, for example, an alighting point desired by the user (hereinafter, also referred to as a desired alighting point) and the number of people. The alighting point and the number of persons may be selected by having a pull-down menu displayed on the display 15, and allowing the user to tap items from among the menu. The information to be displayed in the pull-down menu may have been stored in advance in the auxiliary storage unit 13, or may be inquired of the server 30. In addition, the control device 101 asks the user to hold the credit card 60 over the payment terminal 10, for example. Based on the information obtained in this way and the information about the payment terminal ID or the payment point stored in the auxiliary storage unit 13 of the payment terminal 10, the control device 101 generates a usage request and transmits it to the server 30.

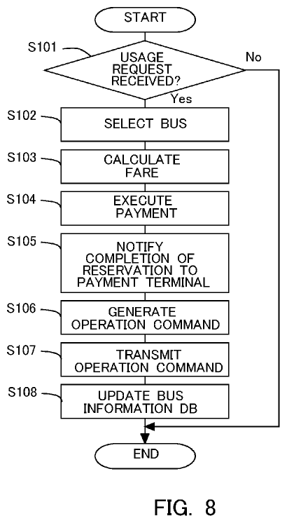

Next, the processing of generating an operation command for a bus in the server 30 will be described. FIG. 8 is a flowchart of processing of generating an operation command for a bus 40 in the server 30 according to a first embodiment. The processing illustrated in FIG. 8 is executed at predetermined time intervals at the server 30.

In step S101, the bus management part 301 determines whether or not a usage request has been received from the payment terminal 10. Note that the information included in the usage request is stored in the user information DB 311. When an affirmative determination is made in step S101, the processing or routine proceeds to step S102, whereas when a negative determination is made, this routine is ended. In step S102, the command unit command part 303 selects a bus 40 for the user to board. The command part 303 selects the bus 40 based on the information included in the usage request and the bus information stored in the bus information DB 312. Specifically, the bus 40 is selected which is capable of moving to the payment point on the payment date and time and then to the alighting point, and which has vacant seats for the number of passengers.

In step S103, the payment part 302 calculates a fare. The information about fares has been stored in advance in the auxiliary storage unit 33. For example, a fare table for calculating fares between bus stops may have been stored in the auxiliary storage unit 33. Also, as an alternative, the fare may have been stored in the auxiliary storage unit 33 as a flat or uniform fee. Further, as another alternative, the fare may be calculated according to distance. The distance between bus stops may have been stored in the auxiliary storage unit 33 in advance, or may be calculated based on the information stored in the map information DB 314.

In step S104, the payment part 302 executes payment. In this case, the payment may be made by using a server managed by a credit card company. Here, note that before making the payment, an inquiry may be made to the user as to whether or not the fare calculated in step S103 is acceptable, so that the payment may be made only when a response indicating that the fare is acceptable is obtained from the user. In this case, information for inquiring whether or not the fare calculated in step S103 is acceptable is transmitted to the payment terminal 10. This information includes the fare and information for displaying a statement that prompts the user to enter a response. Then, when the user taps, for example, a “Confirm” button, information about the fact that the fare has been confirmed is transmitted to the server 30. When the information about the confirmation of the fare is received, the payment part 302 makes a payment.

In step S105, the command part 303 transmits, to the payment terminal 10, information for notifying that the payment has been completed. Note that this information may be transmitted to the user ID 20 associated with the user terminal. Information about the user terminal 20 associated with the user ID has been stored in the auxiliary storage unit 33. The information to be transmitted to the payment terminal 10 or the user terminal 20 includes a command or instruction to display, on the display 15 of the payment terminal 10 or the display 25 of the user terminal 20, the fact that the payment has been completed and the fact that the reservation for the bus 40 has been completed. In the payment terminal 10 or the user terminal 20 that has received this information, an image indicating that the payment has been completed and that the reservation for the bus 40 has been completed is displayed on the display 15 or the display 25.

In step S106, the command part 303 generates an operation command so that the bus 40 departs from its current location and travels via the payment point and the alighting point. At this time, a route of the bus 40 may be generated, and the operation command may include the route of the bus 40. This operation command may, for example, cause the display 46 of the bus 40 to show an image guiding the route.

Then, in step S107, the command part 303 transmits the operation command to the bus 40. Further, in step S108, the command part 303 updates the bus information DB 312. The command unit 303 enters the new route in the corresponding route field of the bus 40, and updates the fields for the stop point, the stop date and time, the user ID, and the vacant seat, respectively. At this time, if necessary, the records are changed so that the stop points are arranged in the order of stops on the route of the bus 40.

As described above, according to the first embodiment, the bus 40 is dispatched when triggered by a user making a payment. Therefore, it is not necessary for the user to pay the fare in the bus 40 after boarding the bus 40, and hence, there is no need for the bus 40 to be equipped with a system for payment. As a result, a space for passengers can be made wider. In addition, the alighting point is determined before boarding, so that the route of the bus 40 can be determined at an early stage. Further, the fare can also be determined before boarding. Also, there is no need to make a cumbersome reservation.

In addition, in the case of paying the fare in the bus 40, if the user takes a long time to pay, the bus 40 may not be able to depart, causing inconvenience to other users and making it difficult to operate the bus on time. Such a problem can also be solved by making a payment before boarding the bus 40.

Moreover, electric power and communication lines required for operating the payment terminal 10 can be provided from a corresponding store. Therefore, less capital investment is required. In addition, users gather at the store, thus making it possible for the store to increase sales.

### Second Embodiment

In a second embodiment, incentives are provided to stores. Also, coupons are issued to users so that the users can receive discounts on prices at stores. Here, the stores can expect an increase in sales from passengers for the bus 40, but on the other hand, they can incur losses in order to provide electric power and communication lines to the payment terminal 10. On the other hand, for example, in cases where the passengers of the bus 40 make payments, the server 30 pays to the stores an amount corresponding to the amount of each payment or the number of passengers, thereby compensating for the above-mentioned losses.

In addition, by issuing coupons to users, it is possible to increase the sales of the stores. For the users, too, they are able to purchase goods or receive provision of services at discount prices, so that the use of the bus 40 is promoted. A coupon may be transmitted to a user terminal 20 of a user, for example, triggered by the fact that a payment has been made. The user can wait while shopping in a store or the like until the bus 40 arrives. Here, note that in the second embodiment, an example will be described in which the server 30 provides an incentive to a store and provides a coupon to a user, but only one of them may be provided.

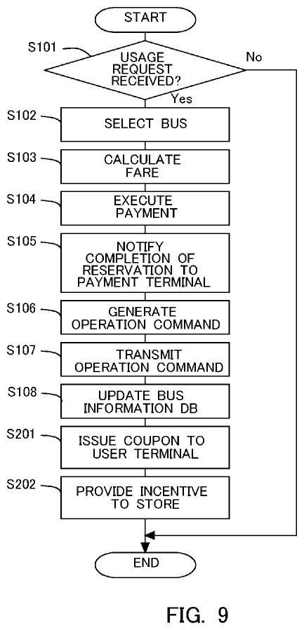

Next, the processing of providing an incentive to a store and providing a coupon to a user at the server 30 will be described. FIG. 9 is a flowchart of processing of providing an incentive to a store and providing a coupon to a user in the server 30 according to the second embodiment. The processing illustrated in FIG. 9 is executed at predetermined time intervals at the server 30. Here, note that those steps in FIG. 9 in which the same processing is performed as in the flowchart illustrated in FIG. 8 are denoted by the same reference signs, and the description thereof will be omitted.

In the flowchart illustrated in FIG. 9, when the processing in step S108 is completed, the processing or routine proceeds to step S201. In step S201, the command part 303 issues a coupon to the user terminal 20. At this time, the coupon associated with a store in which the payment terminal 10 is located is issued. This allows, for example, an image of the coupon to be displayed on the display 25 of the user terminal 20. Information about the coupon is stored, for example, in the auxiliary storage unit 23 of the user terminal 20, and can be displayed on the display 25 at any time by the user making a predetermined input. Information about coupons associated with stores is stored in the payment terminal information DB 313.

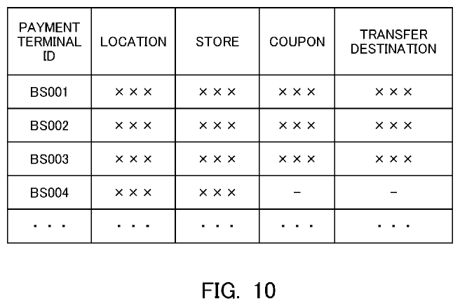

Here, FIG. 10 is a view illustrating an example of a table structure of the payment terminal information DB 313 according to the second embodiment. The payment terminal information DB 313 has fields for payment terminal ID, location, store, coupon, and transfer destination. The fields for payment terminal ID, location, and store are the same as those in FIG. 5, and hence, the description thereof will be omitted. In the coupon field, information about coupons to be provided to users is entered. The coupons provided to users can include, for example, coupons that can be used as cash at stores, coupons that allow users to receive predetermined discounts, coupons that allow users to receive predetermined extras, coupons that allow users to receive predetermined points, coupons that increase the percentage of points awarded, and so on. Also, the coupons may be used not only for the purchase of goods, but also for the provision of services. Other information beneficial to users may be entered in the coupon field. The information entered in the coupon field is transmitted from the store terminal 50 by, for example, an employee of the store.

In the transfer destination field, information about a transfer destination at the time of transferring to each store the charges for use of electricity, communication lines, and location is entered. For example, information about a bank account for transferring the usage fee is entered. The information entered in the transfer destination field is transmitted from the store terminal 50 by an employee of the store.

Returning to FIG. 9, in step S202, the payment part 302 provides an incentive to the store. As an incentive, for example, a few percent of the usage fee for the bus 40 paid by the user may be provided to the store, or a uniform or flat amount may be paid for each usage of the user. Also, as another alternative, an amount of fee corresponding to the usage of the user may be paid for each day, each week, each month, or the like. Further, as a further alternative, a predetermined amount of fee may be paid as a basic fee, even in cases where the user has no use for the bus. The transfer destination corresponding to the store ID of the store is extracted from the transfer destination field illustrated in FIG. 9, and the payment part 302 performs the transfer online. When the transfer is completed, information about the fact that the incentive has been provided is transmitted to the store terminal 50. This information may include a command or instruction to display, on the display of the store terminal 50, an image indicating that the incentive has been provided. In addition, alternatively, this information may be transmitted by e-mail.

As described above, in the second embodiment, coupons are issued to users, so that the use of the bus 40 can be promoted, and sales at stores can be increased. In addition, since usage fees are paid to stores in return for arranging the payment terminals 10 in the stores, it is possible to suppress the stores from incurring disadvantages.

### OTHER EMBODIMENTS

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to dispatch a bus to a predetermined facility in response to receiving information about payment from a terminal that is arranged in the predetermined facility to make a payment of a usage fee for the bus.

2. The information processing apparatus according to claim 1, wherein the information about the payment includes information about a boarding point and an alighting point of a user who has made the payment; and
the controller is configured to generate a route for the bus based on the information about the payment, and transmits the route to the bus.

3. The information processing apparatus according to claim 2, wherein the controller is configured to calculate an amount of the payment based on the boarding point and the alighting point.

4. The information processing apparatus according to claim 1, wherein the controller is configured to dispatch the bus to a store as the predetermined facility.

5. The information processing apparatus according to claim 4, wherein the controller is configured to transmit information about a discount of prices at the store to a terminal of a user who has made the payment.

6. The information processing apparatus according to claim 1, wherein the controller is configured to transmit information about an incentive to the terminal of the predetermined facility, in cases where a user has made the payment.

7. The information processing apparatus according to claim 1, further comprising:
a memory configured to store information about the predetermined facility.

8. An information processing method comprising:
dispatching, by a computer, a bus to a predetermined facility in response to receiving information about payment from a terminal that is arranged in the predetermined facility to make a payment of a usage fee for the bus.

9. The information processing method according to claim 8, wherein
the information about the payment includes information about a boarding point and an alighting point of a user who has made the payment;
the method further comprising generating, by the computer, a route for the bus based on the information about the payment, and transmits the route to the bus.

10. The information processing method according to claim 9, further comprising:
calculating, by the computer, an amount of the payment based on the boarding point and the alighting point.

11. The information processing method according to claim 8, further comprising:
dispatching, by the computer, the bus to a store as the predetermined facility.

12. The information processing method according to claim 11, further comprising:
transmitting, by the computer, information about a discount of prices at the store to a terminal of a user who has made the payment.

13. The information processing method according to claim 8, further comprising:
transmitting, by the computer, information about an incentive to the terminal of the predetermined facility, in cases where a user has made the payment.

14. The information processing method according to claim 8, further comprising:
storing, by the computer, information about the predetermined facility in a memory.

15. A non-transitory storage medium storing a program for causing a computer to dispatch a bus to a predetermined facility in response to receiving information about payment from a terminal that is arranged in the predetermined facility to make a payment of a usage fee for the bus.

16. The non-transitory storage medium storing a program according to claim 15, wherein
the information about the payment includes information about a boarding point and an alighting point of a user who has made the payment; and
the program is configured to cause the computer to generate a route for the bus based on the information about the payment, and to transmit the route to the bus.

17. The non-transitory storage medium storing a program according to claim 16, wherein
the program is configured to cause the computer to calculate an amount of the payment based on the boarding point and the alighting point.

18. The non-transitory storage medium storing a program according to claim 15, wherein
the program is configured to cause the computer to dispatch the bus to a store as the predetermined facility.

19. The non-transitory storage medium storing a program according to claim 18, wherein
the program is configured to cause the computer to transmit information about a discount of prices at the store to a terminal of a user who has made the payment.

20. The non-transitory storage medium storing a program according to claim 15, wherein
the program is configured to cause the computer to transmit information about an incentive to the terminal of the predetermined facility, in cases where a user has made the payment.
